(19) United States
(12) Patent Application Publication
(10) Pub. No.: US 2024/0260754 A1
(43) Pub. Date: Aug. 8, 2024

(54) Coffee Pod Holder

(71) Applicant: Cameron Todd Gunn, Miami, FL (US)

(72) Inventor: Cameron Todd Gunn, Miami, FL (US)

(21) Appl. No.: 18/106,565

(22) Filed: Feb. 7, 2023

(51) Int. Cl. A47B 88/994

(52) U.S. Cl. CPC A47B 88/994

(57) ABSTRACT

Embodiments disclose a novel form of reusable coffee pods holder which has three separate trays within the drawer or can have a single drawer with dividers to separate the various stages of the reusable coffee pod or capsule. The single drawer also contains the mesh which allows water and coffee grinds to drop to the bottom of the drawer away from the coffee pod. The assembly can be completely enclosed with a housing or has the sides and back open which will allow airflow. The disclosed assembly is easy to use, better organized, easily cleanable, and developed from high-quality material to provide superlative and sustainable performance to its users.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a coffee pod holder and, in particular, it relates to an improved coffee pod holder which can store various stages of reusable coffee pods in different drawers.

### Description of the Related Art

With the introduction of the single coffee machines such Keurig and Nespresso, single use coffee pods are widely used. They can also be called coffee capsules. The single coffee pod is typically made of plastic with aluminum foil top that contains the coffee. The single coffee pod is placed into the single coffee machines and produces a single cup of coffee. The single coffee pods come in different flavors and tastes. They are convenient for the user and ideal for workspace and home environments. There is a need to store the coffee pods and coffee pod holders that fit under the coffee machine provide space saving for the kitchen and provide adequate storage. There are several types and shapes of coffee pod holders. There are some coffee pod holders that are vertical, and other that rotate circularly. The different types of coffee pod holders provide a convenient place to hold the single coffee pods.

There are concerns with the disposable nature of the single use coffee pod and its effect on the environment. Although the plastic on the coffee pod is recyclable but it is a specialized procedure due to the type of plastics used. Most of the recycling facilities do not recycle this type of plastic. There are very few of the coffee pods are recycled unless there is a specific recycling program by the manufacturers of the coffee pods. Even if the manufactures recycling program is developed, many users do not use the program. There are estimates the 30 billion coffee pods are disposed of in a year. The disposable single use coffee pods fill landfills with plastics that do not decompose for hundred years or more.

Nespresso recently announced that it will have coffee pods or capsules that are decomposable. This means that it will decompose in the composter in 180 days. It must be done under specific conditions that do not occur naturally in a landfill. They rely on the consumer to compost as a practice.

The solution to reducing the environmental effects of disposable coffee pods is to use reusable coffee pods or capsules. They are typically made of plastic with stainless steel mesh with a hinged or removable lid. They can be made of aluminum as well as stainless steel. They are environmentally friendly and save money for the user. It is estimated that a consumer could save $500 annually based on two coffee servings per day by using a reusable coffee pod.

The issue with the reusable coffee pod is the setup for the cleaning of the pods, which are usually just rinsed out. They need to have a place to store the rinsed coffee pods. The users typically use several pods prior to rinsing so they are stored dirty in coffee pod holders that typically do not have removable drawings for cleaning. It is also typical that the user will rinse several coffee pods at one time and return to the coffee pod holder but they accumulate water. Although the above-mentioned products provide the utility of storage, they are not designed to be used with reusable coffee pods or capsules.

By looking at prior art, multiple advancements have been seen in coffee pod holders. For instance, a US patent 20140097120A1 implies a coffee pod tray is provided with a plurality of dividers that may be held by a support frame in a first position to form rows for aligning coffee pods of a first size. The dividers are held by the support in a second position to form rows for aligning coffee pods of a second size.

By looking at the prior art, multiple advancements have been seen but the utility of these holders for reusable coffee pods is still questionable. Thus, in view of the above, there is a long-felt need in the industry to address the aforementioned deficiencies and inadequacies. The approaches described in this section are approaches that could be pursued, but these do not necessarily approach that have been previously conceived or pursued. Therefore, unless otherwise indicated, it should not be assumed that any of the approaches described in this section qualify as prior art merely by virtue of their inclusion in this section.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### BRIEF SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a coffee pod holder, which is suitable for use of reusable pods or capsules, is provided, as shown in and/or described in connection with at least one of the figures.

Another object of this invention is to provide a new and improved coffee pod holder structure that includes a substantially rectangular and box-like housing having one or more slots and one or more dividers integrated within the housing, one or more drawers, each drawer comprising a front panel, a back panel, a right panel, a left panel, a bottom panel, one or more handles connected to the outside portion of the front panel, one or more labels connected to the outside portion of the front panel, and one or more selectively removable mesh mats configured to lay flush to the top surface of their corresponding bottom panel during use. The one or more slots and the one or more dividers are configured to cooperatively receive and align the one or more drawers in parallel during use. The mesh bottom insert is placed in the drawers for drainage and to allow for coffee grounds to fall to the bottom of the tray. The mesh bottom inserts are removeable for cleaning. Each drawer is labeled with one of the three labels: Clean, Filled, and Used. In some embodiments, each drawer has a corresponding tray vertically aligned below the drawer. In some embodiments, each tray has drawer tray slot, consisting of protruded lip that fits within the tray slot within the housing bottom panel for smooth drawer movement in the horizontal position.

In the first embodiment, the coffee pod holder has three separate trays the contain the mesh insert panel that within the drawer sections and the drawers fit within the housing container. In another embodiment, there is a single drawer with dividers to separate the various stages of the reusable coffee pod or capsule. The single drawer also contains the mesh which allows water and coffee grinds to drop to the bottom of the drawer away from the coffee pod. In one embodiment, the coffee pod holder is completely enclosed with a housing and another embodiment has the sides and back open which will allow air flow. Another embodiment utilizes wire bars to support the coffee pod and has a removable tray below the supported wire bars. The removable tray below the pods allows for grinds and dripping water to be collected. The removable tray can be removed and cleaned when required. Another embodiment includes additional storage for coffee and used grounds which will match the shape of coffee pod holders. There are two embodiments of the additional containers with different configurations of opening the containers.

It is another objective of the invention to provide a main assembly made of high-quality material aimed to provide an improved assembly that can be utilized for a longer period of time without affecting its performance.

The object of the invention is to provide a coffee pod holder assembly of the above-mentioned kind, which is simple and inexpensive in construction, manufacturing, filling, and refilling.

Thus, it is the objective to provide a new and improved reusable coffee pod holder assembly. Other aspects, advantages and novel features of the present invention will become apparent from the detailed description of the invention when considered in conjunction with the accompanying drawings.

This brief summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying drawings illustrate the embodiments of apparatuses, methods and other aspects of the disclosure. Any person with ordinary skills in the art will appreciate that the illustrated element boundaries (e.g., boxes, group of boxes, or other shapes) in the figures represent an example of the boundaries. In some examples, an element shown with sharp corner when the component may be rounded for better appearance. Furthermore, the elements may not be drawn to scale.

Various embodiments will herein be described in accordance with appended drawings, which are provided to illustrate, not limit, the scope wherein similar designations denote similarly and which:

FIG. 1 is a perspective view of the three-drawer coffee pod holder shown in drawers-open and drawers-closed positions.

FIG. 2 is a perspective view of the three-drawer coffee pod holder of FIG. 1 with one drawer open.

FIG. 3 is a perspective view of the three-drawer coffee pod holder of FIG. 1 with all drawers removed from the coffee holder pod housing.

FIG. 4 is a perspective view of the mesh insert utilized by the three-drawer coffee pod holder of FIG. 1.

FIG. 5 is a perspective view of another embodiment of a three-drawer coffee pod holder wherein the housing has no side panels and no back panel.

FIG. 6 is a perspective view of a singular drawer from the coffee pod holder of FIG. 1 shown highlighting the drawer fin.

FIG. 7 is a perspective view of a reusable coffee pod.

FIG. 8 is a perspective view of a single drawer coffee pod holder in open and closed positions.

FIG. 9 is a perspective view of a coffee pod holder.

FIG. 10 is a perspective view of the coffee pod holder of FIG. 9 with the drawers and trays removed from the housing.

FIG. 11 is a perspective view of a removable tray of the coffee pod holder of FIG. 9.

FIG. 12 is a perspective view of a three-drawer coffee pod holder having a coffee container and a used ground container.

FIG. 13 is a perspective view of the three-drawer coffee holder of FIG. 12 with the coffee container and the used ground container in an open position.

FIG. 14 is a perspective view of a three-drawer coffee holder having a coffee specific and used grounds specific drawers.

FIG. 15 is a perspective view of the three-drawer coffee holder of FIG. 14 with the coffee specific drawer removed to highlight the internal dividers.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The various embodiments of the reusable coffee pod holder apparatus and methods to open and close the holder are described in the manner of storing reusable coffee pods. The present disclosures describe certain embodiments in the context of reusable coffee pod storage due to particular utility in this context.

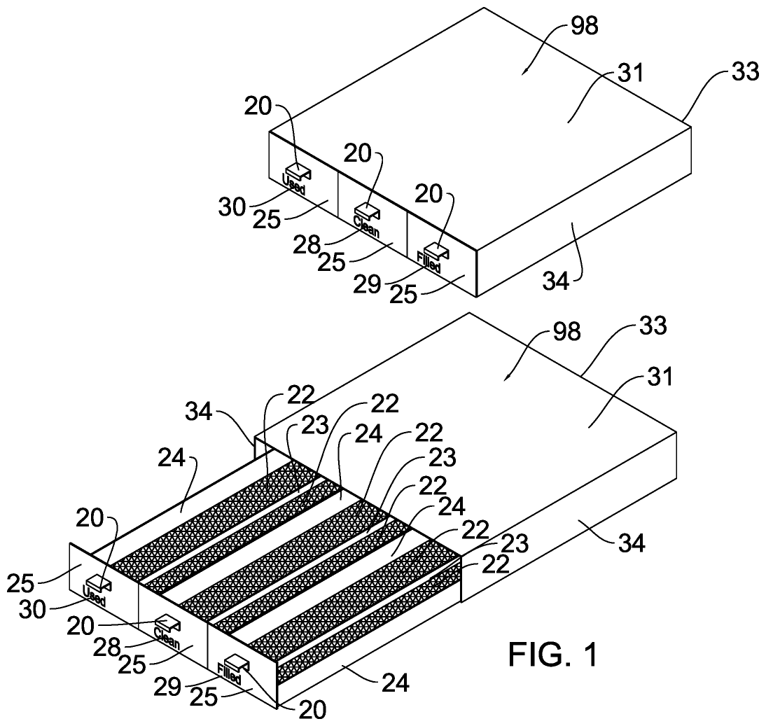

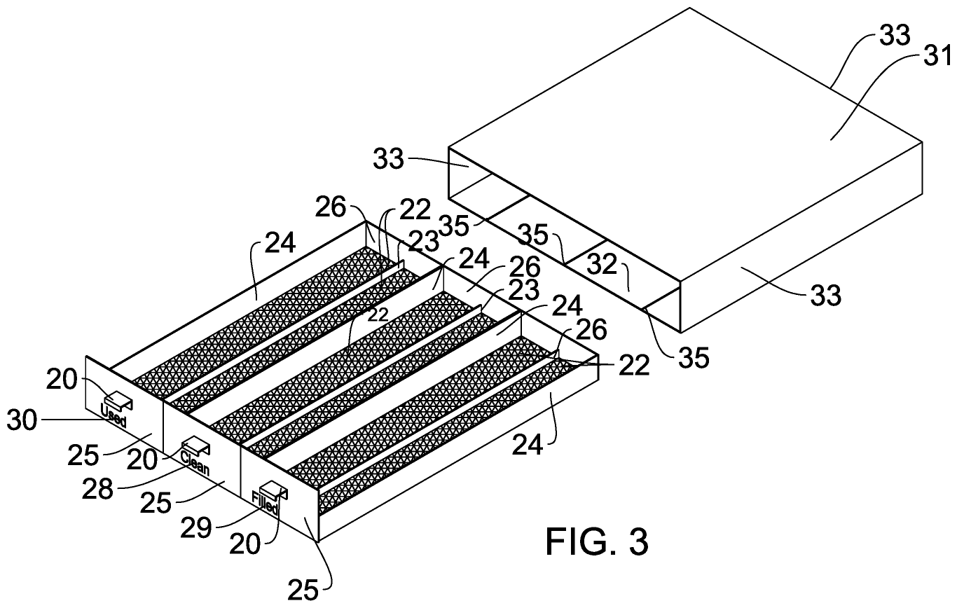

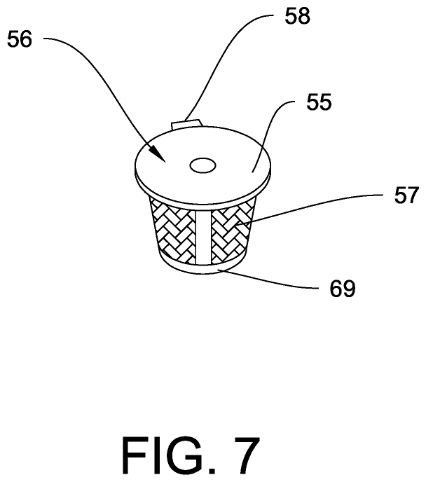

With reference to FIG. 1, shows the perspective view of the three-drawer coffee pod holder assembly 98 in the open and closed position. In the closed position, each drawer has drawer front panel 25, handle 20, drawer side panels 24, and drawer back panel 26 which are connected by adhesive or other manners such as screws. The drawer front panel 25 can be made of metal, plastic or wood. One drawer has the used label 30. Another drawer had the clean label 28 and the other drawer had the filled label 29. The labels are placed to indicate what each drawer will contain during the various phases of using a reusable coffee pod assembly 56 as shown in FIG. 7. The enclosure of the drawers as shown in the closed and open position consists of housing side panel 34, housing bottom panel 32 and housing top panel 31. Although not shown the housing back panel 33 is indicated and is solid. The housing side panel 34, housing bottom panel 32, housing top panel 31 and housing back panel 33 are connected by welding seals in the case of metal or other methods of creating the housing for the drawers. The housing side panel 34, housing bottom panel 32, housing top panel 31 and housing back panel 33 can be made of wood, metal, or plastic. For a different look the housing top panel 31 can also be made of glass. The housing side panel 34, housing back panel 33 and housing top panel 31 could be made of metal and bent in the shape required. The housing bottom panel 32 (not shown in FIG. 1 but shown in FIG. 3) would be metal and welded to the bent shape. In addition, the housing side panel 34, housing back panel 33, housing top panel 31 and housing bottom panel 32 could be made with a plastic mold or with plastic sheets that are fused together. Adhesives are another option of connecting the housing side panels 34, housing bottom 32, housing top panel 31 and housing back panel 33.

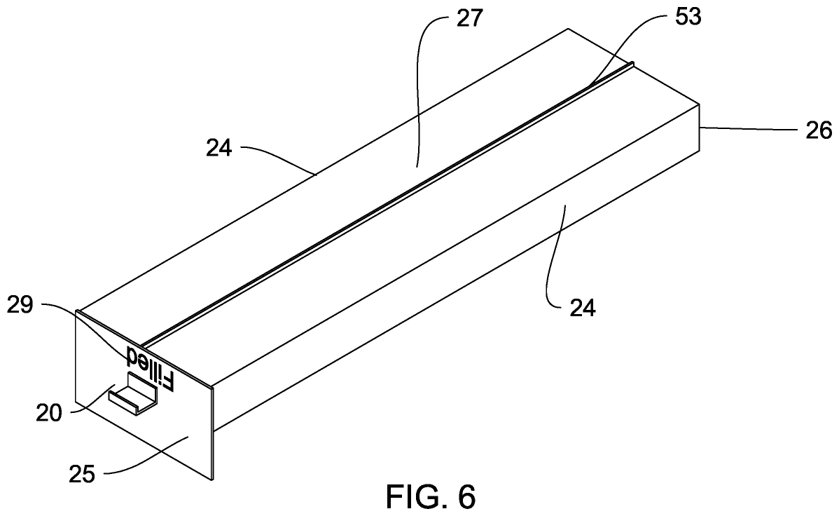

In the open position of FIG. 1 the drawers can be illustrated. The housing container opening is slightly larger than the drawers allowing drawers to slide within the housing. Each drawer has drawer front panel 25 with handle 20 that is connected to drawer side panels 24, drawer bottom panel 27 and drawer back panel 26. The drawer construction is better illustrated in FIG. 3 and FIG. 6 where the drawers are removed from the housing of the three-drawer coffee pod holder assembly 98. In FIG. 1 the middle divider 23 is shown in the middle of drawer. The middle divider 23 is to separate the coffee pod assembly 56 into two sections. For illustration purposes, the three-drawer coffee pod holder assembly 98 has two sections per drawer, a smaller version may only have one section per drawer which removes the requirement for the middle divider 23. Although not shown in FIG. 1 but shown in FIG. 6 there is a drawer bottom panel 27 that holds the mesh 22 in place. Mesh 22 can be made of plastic, metal, and silicone. Mesh 22 is used to allow the coffee pod assembly 56 to drip dry and allow excess coffee grounds to drop to the drawer bottom panel 27. Mesh 22 is mesh with several holes or square sections or other shapes with thin walls that interconnect at certain thickness. The surface area of mesh 22 is small such that water will drain easily and excess coffee grinds will fall to the tray bottom panel 27 and not affect the coffee pod assembly 56. The mesh 22 is easily removed from the tray since it inserted and not attached. The mesh 22 is easily cleaned as required.

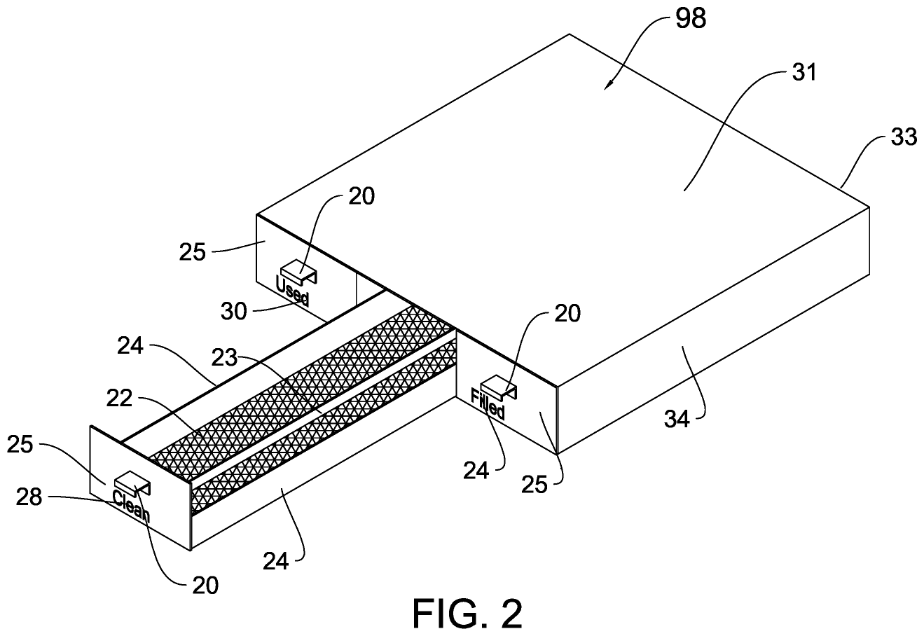

In FIG. 2, the three-drawer coffee pod holder assembly 98 is shown with one drawer open to illustrate the independent movement of each drawer. As in FIG. 1 the housing section consists of housing top panel 31, housing back panel 33 (not visible in FIG. 2 but is filling in the back of the housing), housing side panel 34 and housing bottom 32 (not shown in FIG. 2). In FIG. 2 the drawer with clean label 28 is in the open position. The drawer with used label 30 with drawer front panel 25 and handle 20 is in the closed position. The drawer with the filled label 24 with drawer front panel 25 and handle 20 is in the closed position.

In reference to FIG. 3, the drawers are completely removed to show the construction of the drawers. The drawer with used label 30 consists of drawer front panel 25, handle 20, drawer back panel 26, middle divider 23 and drawer bottom panel 27 (not shown in FIG. 3 but shown in FIG. 6) that are connected. The drawer can be made of plastic, metal or wood. The components of the drawer are connected by welding or adhesives when using metal or plastic sheets. The drawer could be formed with plastic mold in the case of plastics. There are several methods that could be used to construct the drawer which is known to those skilled in the art. The drawer with clean label 28 consists of drawer front panel 25, handle 20, drawer back panel 26, middle divider 23 and drawer bottom panel 27 (not shown in FIG. 3 but shown in FIG. 6) are connected to together. The drawer with filled label 28 consists of drawer front panel 25, handle 20, drawer back panel 26, middle divider 23 and drawer bottom panel 27 (not shown in FIG. 3 but shown in FIG. 6) are connected. Within each drawer section, mesh 22 is placed. The housing of the three-drawer coffee pod holder assembly 98 consists of housing top panel 31, housing bottom panel 32, housing back panel 33 and housing side panels 34 are connected together. Within housing bottom panel 32, there is drawer slot 35 which is slot for the drawers to slide in the correct direction. There is drawer slot 35 is shown for each drawer. The drawer slot 35 is not essential to the operation as the drawers will slide in and out without the drawer slot 35. Further description of the slot is discussed later in the specifications when describing FIG. 6.

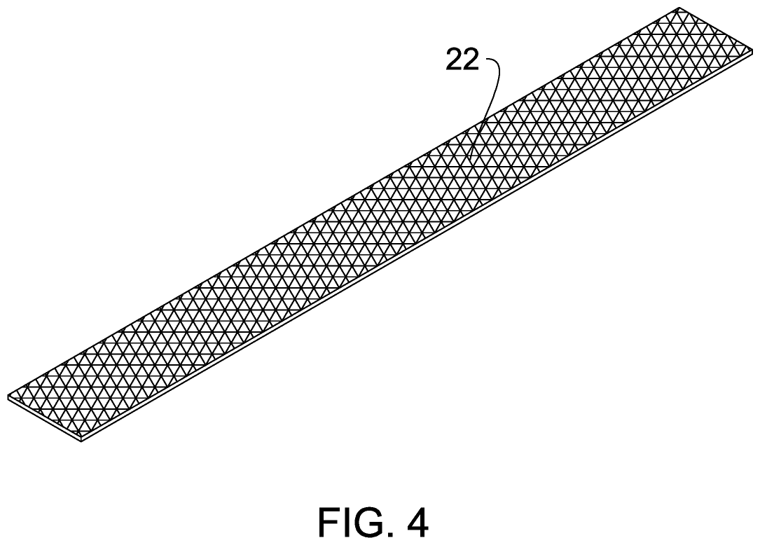

In reference to FIG. 4, mesh 22 is shown separately from the three-drawer coffee pod holder assembly 98. Mesh 22 is removeable and provide the separation of water or coffee grinds from the coffee pod assembly 56. Mesh 22 is easily rinsed or washed after being removed from the drawers.

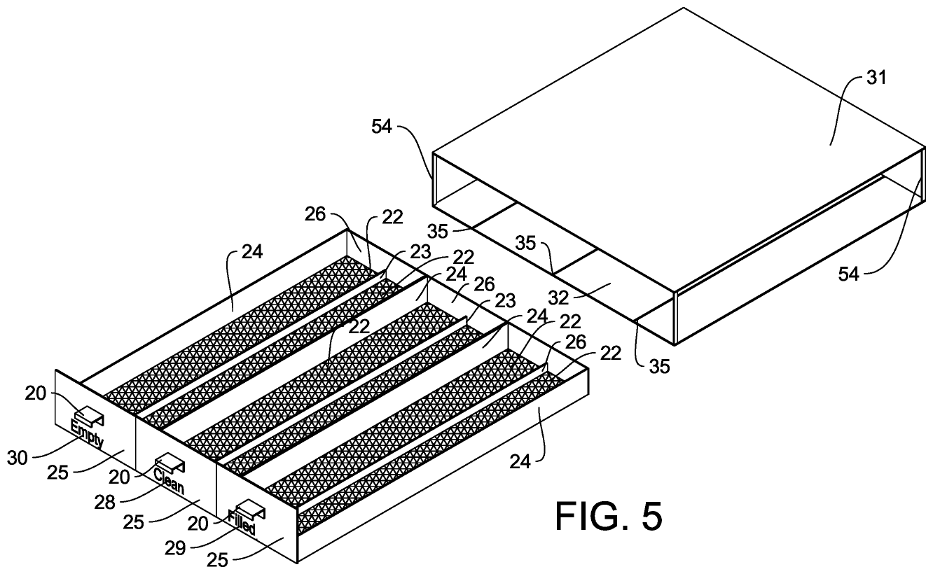

In reference to FIG. 5 which is like FIG. 3 but without housing side panels 34 or housing end panel 34. The drawers are constructed in the exact way shown in FIG. 3. Instead of housing side panels 34 and housing back panel 33, there are corner post 54 which connect with the housing top panel 31 and housing bottom panel 32. There are four corner post 54 at each corner to support the housing top panel 31. The bottom panel 32 has three drawer slots 35. The same construction materials can be used as discussed previously in the specification. In the case of FIG. 5, glass could be used for housing top panel 31. The openness of the apparatus of FIG. 5 allows for air flow through the apparatus. All the other components for the drawers remain the same as FIG. 1-4.

In reference to FIG. 6 which illustrates one of the drawers, with filled label 29 shown upside down to illustrate the construction of the drawer. The drawer bottom panel 27 is connected to drawer front panel 25, drawer side panels 24 and drawer back panel 26 (not shown in FIG. 6 but shown in FIG. 3). On the drawer bottom panel 27 there is drawer slot lip 53 that will slide in the drawer slot 35 shown in FIG. 3. As discussed previously in the specification, the drawer slot lip 53 is optional as it is not essential to the operations of the drawer.

In reference to FIG. 7, reusable coffee pod assembly 56 is shown. The reusable coffee pod assembly 56 consists of pod top 55, pod hinge 58, pod side 57 and pod bottom 69 that are connected. The pod top 55 opens upwards utilizing pod hinge 58. Coffee in inserted reusable coffee pod assembly 56 for each use. The pod top 55 and pod hinge are typically made of plastic while pod side 57 is made of stainless-steel mesh with some plastic frame. The pod bottom 69 is typically made of plastic or stainless steel or aluminum. The reusable coffee pod assembly 56 is inserted in the coffee machine to produce the coffee. After using the reusable coffee pod assembly 56, it is removed and placed in the drawer with used label 30 to be cleaned at different time. After the accumulation of the reusable coffee pod assembly 56 in the drawer with used label 30, the reusable coffee pod assembly 56 is rinsed and put into the drawer with clean label 28. After the accumulation of the reusable coffee pod assembly 56 in the drawer with clean label 28, the user will fill the reusable coffee pod assembly 56 with coffee and place in the drawer with filled label 29 for use when user wants to brew another cup of coffee. There are several types of reusable coffee pods in the industry that could be used. One type is shown for simplicity of the specification.

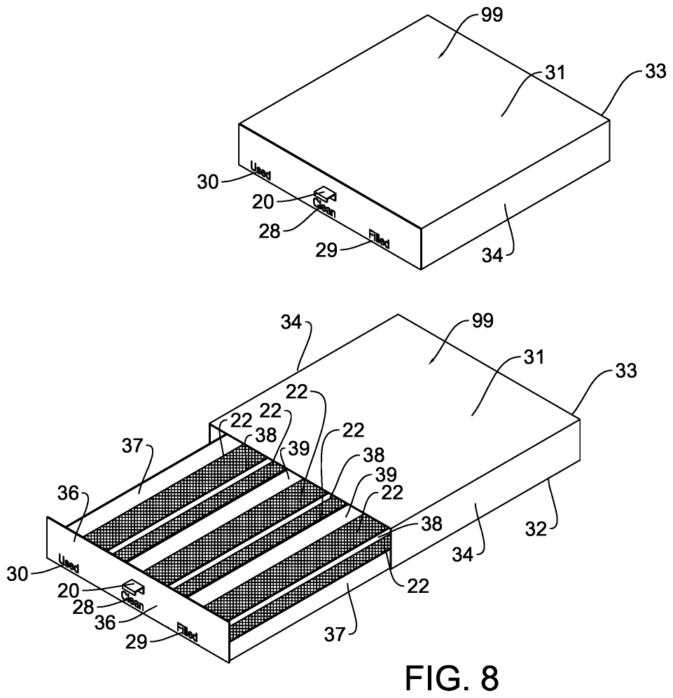

In reference to FIG. 8, the single drawer coffee pod holder assembly 99 is shown in the open and closed positions. It is like FIG. 3 but has a single drawer. As with FIG. 3 it has housing top 31, housing bottom 22 (not shown in FIG. 8), housing back 33 (not shown in FIG. 8) and housing side 34 are all connected to form a housing with open front. The drawer consists of single drawer front 36, single drawer back 97 (not shown but it is similar FIG. 3), single drawer sides 37 that are connected. Within the single drawer there are single drawer small dividers 38 and single drawer large dividers which separate the reusable coffee pod assembly 56. On the single drawer front 36, there is a single handle 20 to open and close the drawer. On the single drawer front 36 there is the clean label 28, filled label 29 and the used label 30 to show the sections of the single drawer for the different phases of the reusable coffee pod assembly 56. The single drawer slides within the housing container for the single drawer coffee pod holder 99.

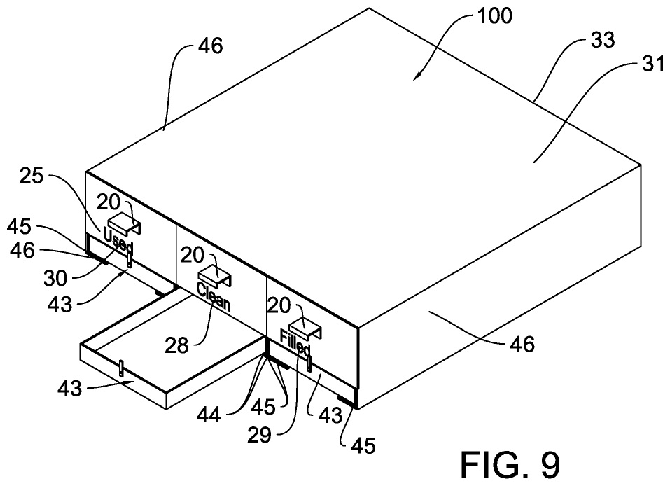

In reference to FIG. 9, it illustrates another version of the reusable coffee pod holder that has removable bottom trays. The coffee pod holder with removable tray assembly 100 consists of housing top panel 31, bent housing side panels 45, and housing end panel 33 (not shown in FIG. 9) that form the container for the coffee pod holder with removable tray assembly 100. At the front of the coffee pod holder with removable tray assembly 100 are drawer front panels 25 with three drawers with handle 20. In addition, the drawer front panels have used label 30, filled label 29, and clean label 28. In FIG. 9, the coffee pod holder with removable tray assembly 100 is shown in the closed position with exception of the bottom tray assembly 43 is in the open position. Although visible in FIG. 9, bottom tray support 45 and housing divider 44 are shown but will be explained in subsequent sections of the specification.

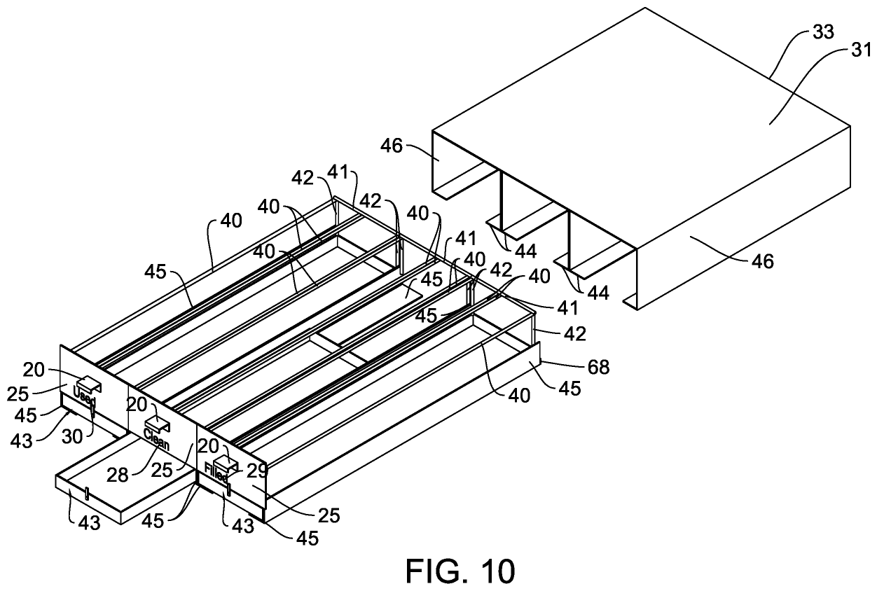

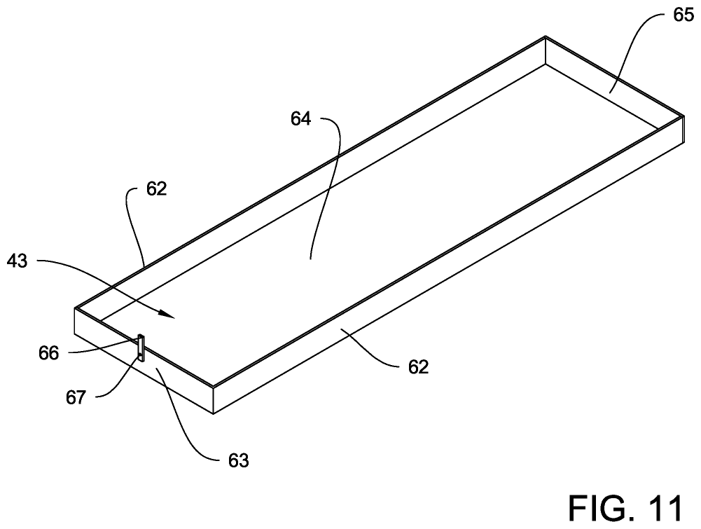

In FIG. 10, the perspective view of the coffee pod holder with removable tray assembly 100 is shown with drawers removed from the housing. In this embodiment, bars form the drawer where bars are spaced to hold reusable coffee pod assembly 56. In the reusable coffee pod assembly 56, there are rigids at the top which fit within the cross bars 40. Each drawer consists of drawer front panel 25, handle 20, cross bars 40, back bar 41, vertical bars 42, bottom tray support 45 and bottom tray assembly 43. The bottom tray assembly 43 will be described in subsequent sections of the specifications when discussing FIG. 11. In this embodiment, the cross bar 40, back bar 41 vertical bar 42 and drawer front panel 25 are constructed of steel. The materials could also include plastic.

The cross bar 40 is connected to drawer front panel 25 in four different locations by welding. The back bar 41 is connected to various cross bars 40 at the back of the drawer by welding. The cross bars 40 are supported by vertical bars 42 which are welded together. The vertical bars 42 are also connected to the bottom tray support 45 by welding. The bottom tray support 45 is also welded to drawer front panel 25. The combination of drawer front panel 25, cross bars 40, bar back 41, vertical bar 42 and bottom tray support 45 provide the structural components of each drawer. At the back of the tray, bottom tray back stops 68 is welded to bottom tray support 45 to keep the bottom tray assembly 43 from moving backwards. The bottom tray assembly 43 can slide on the bottom tray support 45 which is bent metal. As shown in FIG. 10 the bottom tray assembly 43 is partially open to aid in the understanding of the operation.

In reference to FIG. 10, the housing or container of the coffee pod holder with removable tray 100 is different than other embodiments. It has the similar housing top 31 and housing back 33 but includes housing dividers 44 which are welded to housing top 31 as well bent housing side panels 46. The housing dividers 44 are bent metal that provide a surface for the drawers to slide on. In addition, housing dividers 44 provide support for the housing top 31 for additional weight such as the coffee maker.

The bottom tray assembly 43 can slide out to be cleaned without removing the contents. The bottom tray assembly 43 provides convenience for cleaning.

In FIG. 11, the perspective view of the bottom tray assembly 43 is shown. In this embodiment, the components of the bottom tray assembly 43 is metal although it could be plastic. The bottom tray assembly 43 consists of bottom tray bottom 64 which is welded to bottom tray back 65, bottom tray front 63, and bottom tray sides 62 to form a container or tray. In addition, there is bottom tray lever 66 with bottom tray lever pin 66 which allows bottom tray lever 66 to rotate sideways if required. The bottom tray lever 66 allows the bottom tray assembly 43 to maintain position with the remainder of the drawers. The bottom tray lever 66 also acts as handle to pull out the bottom tray assembly 43.

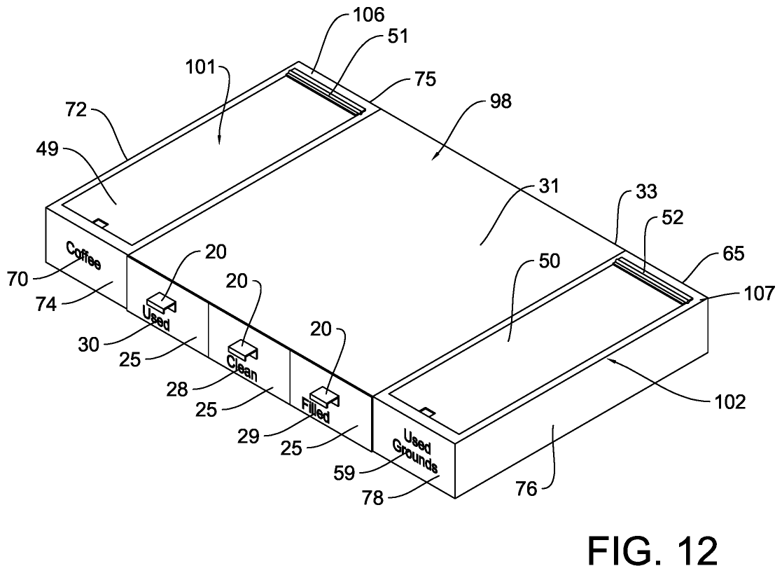

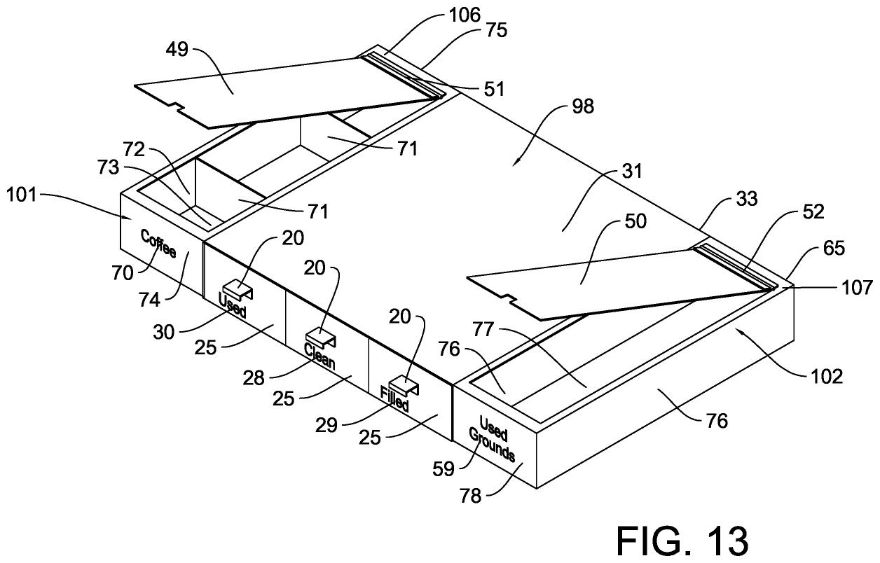

In FIG. 12, the perspective view of three drawer coffee pod holder assembly 98 with two additional containers for Coffee and Used Grounds. FIG. 12 is like FIG. 1 where three drawer coffee pod holder assembly 98 is in the closed position. In FIG. 12, there is addition of coffee container 101 and used ground container 102 that are placed on either side of the drawer coffee pod holder assembly 98. Coffee container 101 consists of coffee container side panel 72 (Not visible in FIG. 12 but shown in FIG. 13), coffee container hinge 51, coffee container back panel 75 (not visible in FIG. 12 but represents a solid side of the coffee container 101), coffee container front panel 74, coffee container bottom panel 73 (Not visible in FIG. 12 but shown on FIG. 13), coffee container lid 104, coffee container top panel 106 and coffee label 70. Coffee container 101 is fully contained to store coffee grounds and can be made of plastic, metal, or wood. The components of the coffee container 101, are either welded together in the case of metal or use of adhesives. In the case of plastics, coffee container 101 could be made of plastic sheets that are glued together or the coffee container 101 could be constructed by mold. Although not shown, it is suggested that coffee container 101 is attached to the side of the three-drawer coffee pod holder assembly 98 with Velcro to allow for easy removal for cleaning.

On the opposite side of the coffee container 101, is the used grounds container 102 which is similarly attached to drawer coffee pod holder 98 with Velcro to allow for easy removal to dispose of used ground. The used ground container 102 is constructed in the same manner and materials as the coffee container 101. The used ground container 102 comprises of used grounds container lid 50, used grounds container hinge 52, used grounds container side panel 76, used grounds container bottom panel 77 (not shown in FIG. 12 but shown in FIG. 13) used grounds container top panel 107 and Used Grounds label 59. All components listed form a sealed container and the parts are welded together or through the use adhesives in the case of metal construction. The components used grounds container 102 could be made of plastic sheets that glued together or they constructed by use of the mold. The components of the used grounds container 102 could be made of wood where the used grounds container hinge 52 would be made of metal or plastic. The operations of the coffee container 101 and used ground container 102 will become more apparent in FIG. 13 description.

In reference to FIG. 13, the perspective view of the three-drawer coffee pod holder assembly 98 with the coffee container 101 in the open position and used grounds container 102 in the open position. The used grounds container hinge 52 is connected to the used grounds container top panel 107 where the used grounds container top 107 has an opening approximately the size of the used grounds container lid 50. The used ground container hinge 52 pivotality opens when the front of the used grounds container lid 50 is lifted to the open position. When in the open position, the used grounds container bottom panel 77 is visible along with used grounds container side panels 76 which forms a container to hold used grounds of coffee after being removed from the reusable coffee pod assembly 56.

Similarly, with coffee container 101, the coffee container hinge 51 is connected to coffee container top panel 106 where there is an opening of approximately the size of the coffee container lid 49. The coffee container hinge 51 pivotality opens when the front of the coffee container lid 49 is lifted from the front. As seen in FIG. 13, the coffee container side panel 72 is shown as well as the coffee container bottom panel 73. In addition, the coffee divider 71 is shown that divides the coffee container 101 into three separate compartments. The coffee container 101 maintains the coffee within the complete container. The addition of coffee dividers 71 allows users to put different coffee types in the differently divided cells.

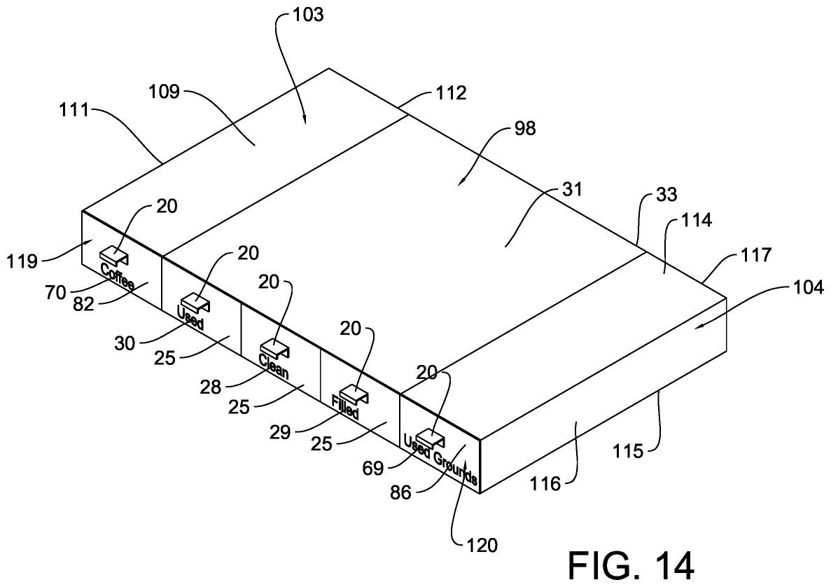

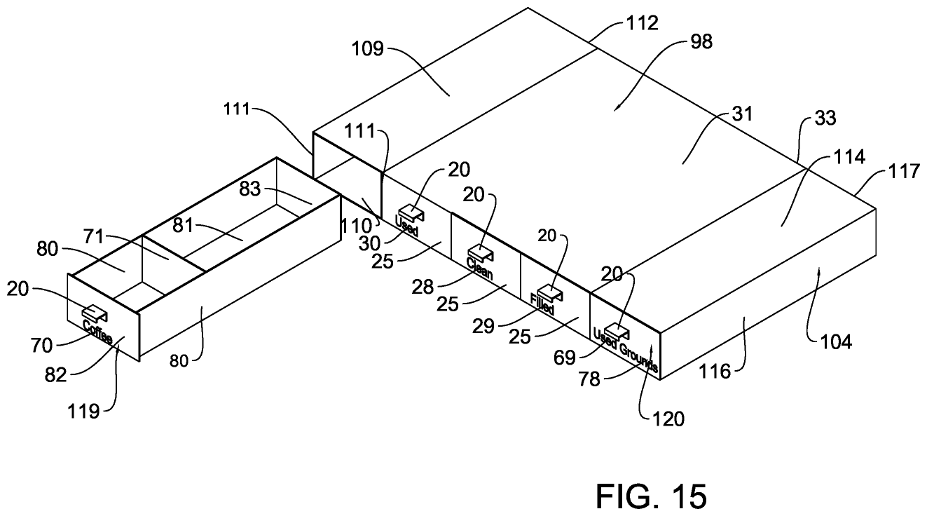

In reference to FIG. 14, the perspective view of the three-drawer coffee pod holder assembly 98 with drawer coffee container 103 (in closed position) and drawer used coffee container 104 (in closed position). The three-drawer coffee pod holder assembly 98 has been described previously in detail. The drawer coffee container 103 is similar to the three-drawer coffee pod holder assembly 98 where there is a housing that is marginally larger than the drawer. The drawer coffee container 103 consists of coffee drawer 119 (to be described later in the specifications) drawer coffee side housing 111 (not visible in FIG. 14 but shown in FIG. 15), drawer coffee top housing 109, drawer coffee back housing 112 (not visible but it solid) and drawer coffee bottom housing 110 (not visible in FIG. 14 but shown in FIG. 15). All components are connected together by welding or by use of adhesion when the material is metal. Other materials such as wood or plastic could be used for construction of the drawer coffee container 103. In the case of plastic, the components could mold. The drawer coffee container 103 can be attached three drawer coffee pod holder assembly 98 by Velcro or by other methods such as molded slots on each section. The drawer coffee container 103 is removeable from the three-drawer coffee pod assembly 98 such that the drawer coffee container 103 can be cleaned. In FIG. 14, the drawer coffee container 103 is in the closed position such only the coffee label 70, coffee container front panel 82 and handle 20 are visible in the figure.

The drawer used ground container 104 is similar to the three-drawer coffee pod holder assembly 98 where there is a housing that is marginally larger than the drawer. The drawer used coffee container 104 consists of used grounds drawer 120 with drawer used grounds side housing 116, drawer used grounds top housing 114, drawer used grounds back housing 117 (not visible but it solid) and drawer coffee bottom housing 115 (not visible in FIG. 14 but is solid). All components are connected by welding or by using adhesion when the material is metal. Other materials such as wood or plastic could be used for construction of the drawer used grounds container 104. In the case of plastic, the components could mold. The drawer used grounds container 104 can be attached three drawer coffee pod holder assembly 98 by Velcro or by other methods such as molded slots on each section. The drawer used grounds container 104 is removeable from the three-drawer coffee pod assembly 98 such that the drawer used grounds container 104 can be cleaned. In FIG. 14, the drawer used grounds container 104 is in the closed position such only the used grounds label 59, drawer used grounds container front panel 86 and handle 20 are visible of the used grounds drawer 120.

In reference to FIG. 15, the perspective view of three drawer coffee pod holder assembly 98 with drawer coffee container 103 and drawer used grounds container 104 with the coffee drawer 119 removed. Although the used grounds drawer 120 is not removed, it has similar components as the coffee drawer 119. All components of the used grounds drawer 120 are not shown for clarity of the drawing. It is intended that coffee drawer 119 will be similar to the used grounds drawer 120.

The coffee drawer 119 consists of drawer coffee container side panel 80, drawer coffee container front panel 82, drawer coffee container bottom panel 81, drawer coffee container back panel 83, coffee label 70 and handle 20. All components are welded together or glued together to form a drawer if the construction of metal was used. Other methods of construction can be used such as plastic or wood. The coffee drawer 119 components are slightly smaller than the housing container so the coffee drawer 119 will slide inside and out.

In FIG. 15, the housing of the container is illustrated with the drawer coffee top housing 109, drawer coffee bottom housing 110, drawer coffee side housing 111 and drawer coffee back housing 112 (not visible but it is solid). The drawer used grounds container 104 is the same as the drawer coffee container 103. Partial of the housing of the drawer used grounds container 104 is shown in FIG. 15. Drawers used grounds top housing 114 is connected to drawer used grounds side housing 116, drawer used grounds bottom housing 115 (Not shown but solid), and drawer used grounds back housing 117 (not shown but solid).

Thus, the reader will see that at least one embodiment of the reusable coffee pod holder provides a reliable, easy-to-use, and functional holder for the storage of reusable coffee pods. The reusable coffee pod holder provides clearly marked drawer sections for each phase of using the reusable coffee pod. One stage is filled where the reusable coffee pod is filled with coffee. Another stage is the used where reusable coffee pod used and placed in the drawer with or without coffee. Another stage is the clean where the reusable coffee pod has been rinsed and is ready to be filled with coffee once it is dry or possibly when a number of pods are cleaned and ready to be filled.

Although the reusable coffee pod holder apparatus has been disclosed in the context of certain embodiments and examples, it is understood by those skilled in the art that the present disclosure extends beyond the specifically disclosed embodiments to other alternative embodiments and/or uses of the reusable coffee pod holder apparatus and obvious modifications and equivalents thereof. In addition, several variations of the reusable coffee pod holder apparatus have been illustrated and described, other modifications, which are within the scope of the present disclosure, will be readily apparent to those of skill in the art.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

What is claimed is:

1. A coffee pod holder for a rectangular tray, the coffee pod holder comprising:
one or more drawers, each drawer comprising:
a front panel;
a back panel;
a right side panel;
a left side panel;
a bottom panel;
one or more handles connected to the outside portion of the front panel;
one or more labels connected to the outside portion of the front panel;
one or more selectively removable mesh mats configured to lay flush to the top surface of their corresponding bottom panel during use; and,
a housing having one or more slots and one or more dividers integrated within the housing;
wherein the one or more slots and the one or more dividers are configured to cooperatively receive and align the one or more drawers in parallel during use.

2. The coffee pod holder of claim 1, wherein the housing is substantially rectangular and box-like in shape.

3. The coffee pod holder of claim 2, wherein each drawer from the one or more drawers further comprises a drawer fin on the outside portion of the bottom panel of the drawer and each slot from the one or more slots further comprises a drawer fin slot on the inside portion of the bottom of the slot wherein the one or more drawer fins are configured to be slidably coupled and engaged with the one or more drawer fin slots during use.

4. The coffee pod holder of claim 2, wherein the one or more drawers comprise a singular drawer.

5. The coffee pod holder of claim 2, wherein each drawer from the one or more drawers further comprises a middle divider protruding from the inside portion of the bottom panel of the drawer and each drawer comprises two opposing selectively removable mesh mats configured to be separated by the middle divider.

6. The coffee pod holder of claim 2, further comprising a first drawer and a second drawer, each drawer comprising:
a front panel;
a back panel;
a right side panel;
a left side panel;
a bottom panel;
one or more handles connected to the outside portion of the front panel; and,
one or more labels connected to the outside portion of the front panel.

7. The coffee pod holder of claim 2, wherein the housing further comprises a right bin and a left bin, each bin comprising:
a selectively closable lid;
one or more labels placed on the exterior of the bin; and,
zero or more bin dividers configured to separate the internal space within each bin into separate portions.

8. A coffee pod holder for a rectangular tray, the coffee pod holder comprising:
one or more drawers, each drawer comprising:
a front panel;
a back panel;
a right side panel;
a left side panel;
a partially open bottom panel;
one or more handles connected to the outside portion of the front panel;
one or more labels connected to the outside portion of the front panel;
one or more selectively removable mesh mats configured to lay flush to the top surface of their corresponding partially bottom panel during use;
one or more trays corresponding to the one or more drawers, each tray comprising:
a front panel;
a back panel;
a right side panel;
a bottom panel;
a lever connected to the outside portion of the front panel and configured to open the tray when its corresponding drawer is opened; and,
a housing having one or more pairs of slots and one or more dividers integrated within the housing;
wherein the one or more pairs of slots and the one or more dividers are configured to cooperatively receive and align the one or more drawers and their corresponding one or more trays in parallel during use;
wherein the one or more drawers are vertically aligned with their corresponding one or more trays during use;
wherein the partially open bottom panels are configured to readily allow matter passing through the mesh mats fall into their corresponding trays.

9. The coffee pod holder of claim 8, wherein the housing is substantially rectangular and box-like in shape.

10. The coffee pod holder of claim 9, wherein the one or more drawers comprises a singular drawer.

11. The coffee pod holder of claim 9, wherein each drawer from the one or more drawers further comprises a middle divider protruding from the inside portion of the bottom panel of the drawer and each drawer comprises two opposing selectively removable mesh mats configured to be separated by the middle divider.

12. The coffee pod holder of claim 9, further comprising a first drawer and a second drawer, each drawer comprising:
a front panel;
a back panel;
a right side panel;
a left side panel;
a bottom panel;
one or more handles connected to the outside portion of the front panel; and,
one or more labels connected to the outside portion of the front panel.

13. The coffee pod holder of claim 9, wherein the housing further comprises a right bin and a left bin, each bin comprising:
a selectively closable lid;
one or more labels placed on the exterior of the bin; and,
zero or more bin dividers configured to separate the internal space within each bin into separate portions.

14. A coffee pod holder for a rectangular tray, the coffee pot holder comprising:
one or more drawers, each drawer comprising:
a front panel;
a rear bar rectangle, wherein each corner of the front panel is connected to its corresponding corner of the rear bar rectangle with a bar;
one or more handles connected to the outside portion of the front panel;
one or more labels connected to the outside portion of the front panel;
one or more trays corresponding to the one or more drawers, each tray comprising:
a front panel;
a back panel;
a right side panel;
a bottom panel;
a lever connected to the outside portion of the front panel and configured to open the tray when its corresponding drawer is opened; and,
a housing having one or more slots and one or more dividers integrated within the housing;
wherein the one or more slots and the one or more dividers are configured to cooperatively receive and align the one or more drawers and their corresponding one or more trays in parallel during use;
wherein the one or more drawers are vertically aligned with their corresponding one or more trays during use;
wherein the one or more drawers are configured to physically prevent the back panels of their corresponding one or more trays from extending past the rear panel of the housing.

15. The coffee pod holder of claim 14, wherein the housing is substantially rectangular and box-like in shape.

16. The coffee pod holder of claim 15, wherein the one or more drawers comprises a singular drawer.

17. The coffee pod holder of claim 15, wherein each drawer from the one or more drawers further comprises a middle divider protruding from the inside portion of the bottom panel of the drawer and each drawer comprises two opposing selectively removable mesh mats configured to be separated by the middle divider.

18. The coffee pod holder of claim 15, further comprising a first drawer and a second drawer, each drawer comprising:
a front panel;
a back panel;
a right side panel;
a left side panel;
a bottom panel;
one or more handles connected to the outside portion of the front panel; and,
one or more labels connected to the outside portion of the front panel.

19. The coffee pod holder of claim 15, wherein the housing further comprises a right bin and a left bin, each bin comprising:
a selectively closable lid;
one or more labels placed on the exterior of the bin; and,
zero or more bin dividers configured to separate the internal space within each bin into separate portions.

20. The coffee pod holder of claim 17, further comprising a first drawer and a second drawer, each drawer comprising:
a front panel;
a back panel;
a right side panel;
a left side panel;
a bottom panel;
one or more handles connected to the outside portion of the front panel; and,
one or more labels connected to the outside portion of the front panel.
